(19) United States
(12) Patent Application Publication
(10) Pub. No.: US 2024/0128072 A1
(43) Pub. Date: Apr. 18, 2024

(54) FLOW RATE SWITCHING MECHANISM AND MASS SPECTROMETER

(71) Applicant: SHIMADZU CORPORATION, Kyoto (JP)

(72) Inventors: Shunki SHIBA, Kyoto-shi (JP); Tomoyoshi MATSUSHITA, Kyoto-shi (JP)

(73) Assignee: SHIMADZU CORPORATION, Kyoto (JP)

(21) Appl. No.: 18/485,311

(22) Filed: Oct. 12, 2023

(30) Foreign Application Priority Data
Oct. 12, 2022 (JP) 2022-163929

(51) Int. Cl. H01J 49/24; F25B 41/42; H01J 49/04

(52) U.S. Cl. CPC H01J 49/24; F25B 41/42; H01J 49/0431

(57) ABSTRACT

A flow rate switching mechanism including: a first section including: a first housing with a passage internally bored through, the passage having a narrowed portion at a distance from one end of the passage, and the narrowed portion having a smaller cross-sectional area than the cross-sectional area of the passage at the one end; a capillary having an internal passage having a smaller cross-sectional area than the cross-sectional area of the narrowed portion; and a hermetic support member supporting the capillary and to provide a seal; a second section having a second housing identical in shape to the first housing, without having the capillary and the hermetic support member; and a three-way valve being alternatively switchable between a first state in which the outlet end is connected to the first inlet end and a second state in which the outlet end is connected to the second inlet end.

### CROSS-REFERENCE TO RELATED APPLICATION

This application claims the priority benefit of Japan application serial no. 2022-163929, filed on Oct. 12, 2022. The entirety of the above-mentioned patent application is hereby incorporated by reference herein and made a part of this specification.

### TECHNICAL FIELD

The present invention relates to a flow rate switching mechanism for switching the flow rate of a gas flowing through a tube, as well as a mass spectrometer including the same.

### BACKGROUND

In a mass spectrometer or similar device having a vacuum chamber, a plurality of vacuum pumps having different levels of operable pressure may be used in order to evacuate the vacuum chamber (for example, see Patent Literature 1 or other related documents).

A mass spectrometer including a plurality of vacuum pumps as mentioned earlier is hereinafter described with reference to FIG. 7. The present mass spectrometer includes an ionizing section 10 configured to generate ions from a sample, an analyzing section 20 configured to detect resultant ions after performing mass separation of the ions, and an evacuating section 30 configured to evacuate the inner space of the analyzing section 20. The analyzing section 20 has a first vacuum chamber 21, second vacuum chamber 22 and third vacuum chamber 23 arranged in this order from the ionizing section 10, having the configuration of a multi-stage differential pumping system in which the degrees of vacuum of the chambers are increased in a stepwise manner in the mentioned order. The evacuating section 30 includes a first pump 31, which is a turbo molecular pump, and a second pump 32, which is a rotary pump. The suction port 33 of the second pump 32 is connected to the first vacuum chamber 21 via a first tube 34, while the discharge port 35 of the same pump is open to the ambient air. The first pump 31 has two suction ports 36 and 37, of which one suction port 36 is directly connected to the second vacuum chamber 22, while the other suction port 37 is directly connected to the third vacuum chamber 23. The discharge port 38 of the first pump 31 is connected to a halfway point on the first tube 34 via a second tube 39.

In such a configuration, the second pump 32 acts as a pump for evacuating the first vacuum chamber 21 to a desired degree of vacuum and maintaining this degree of vacuum, as well as a roughing vacuum pump for evacuating the second and third vacuum chambers 22 and 23 to the operable pressure level of the first pump 31, and also acts as an auxiliary pump for maintaining the back pressure of the first pump 31 by removing air expelled from the first pump 31. For a sufficient removal of hydrogen or similar gases having small molecular weights (“light-weight gases”) by the first pump 31, it is necessary to introduce a gas having a large molecular weight into the section between the first and second pumps 31 and 32. For this purpose, the evacuating section 30 is equipped with an air supplier 40 for sending a small amount of air into the second tube 39. However, during a standby period in which no mass spectrometric analysis is performed (i.e., in a situation in which the first and second pumps 31 and 32 are in operation yet no ion is introduced into the analyzing section 20), the pressure within the second tube 39 becomes lower than during an analyzing period in which a mass spectrometric analysis is ongoing, so that the noise from the second pump 32 may become larger, or a backflow of the oil from the second pump 32 into the first tube 34 may occur. In order to prevent this situation, the flow rate of the air introduced from the air supplier 40 into the second tube 39 during the standby period needs to be higher than the flow rate during the analyzing period. To this end, the air supplier 40 is provided with two types of flow-path-narrowing sections 44 and 47 with different inner diameters so that the flow rate of the air introduced into the second tube 39 can be changed by using the flow-path-narrowing section 44 or 47 depending on the standby or analyzing period.

Specifically, the air supplier 40 includes a first flow path 41 and a second flow path 42 arranged in parallel, where the first flow path 41 has a first valve 43, first flow-path-narrowing section 44 and first air filter 45, while the second flow path 42 has a second valve 46, second flow-path-narrowing section 47 and second air filter 48. Setting the first valve 43 in the open position and the second valve 46 in the closed position creates a state in which the air passing through the first flow path 41 flows into the second tube 39 (“first state”). Conversely, setting the first valve 43 in the closed position and the second valve 46 in the open position creates a state in which the air passing through the second flow path 42 flows into the second tube 39 (“second state”). Each of the first and second flow-path-narrowing sections 44 and 47 includes a capillary consisting of a quartz tube or similar component (not shown). The air which has flown into the first or second flow-path-narrowing section 44 or 47 passes through the capillary, whereby the flow rate of the air is limited. The capillary included in the second flow-path-narrowing section 47 has a smaller inner diameter than the capillary included in the first flow-path-narrowing section 44. Therefore, by controlling the open/close state of the first and second valves 43 and 46 so that the first state as described earlier is created during the standby period and the second state as described earlier is created during the analyzing period, the flow rate of the air introduced from the air supplier 40 into the second tube 39 can be set to be relatively high during the standby period and relatively low during the analyzing period.

### CITATION LIST

### Patent Literature

Patent Literature 1: JP 2020-091988 A (Paragraph 0020 and FIG. 1)

### SUMMARY OF INVENTION

### Technical Problem

However, the previously described configuration has the problem that a considerable number of parts are required for realizing the switching of the flow rate, causing the production cost to be high and the control to be complex.

The present invention has been developed in view of the previously described point. Its objective is to provide a flow rate switching mechanism that can be realized at low cost and is easy to control, as well as a mass spectrometer including the same mechanism.

### Solution to Problem

A flow rate switching mechanism according to one mode of the present invention developed for solving the previously described problem includes:
a first flow-path-narrowing section including: a first housing with a passage internally bored through, the passage having a narrowed portion at a distance from one end of the passage, and the narrowed portion having a smaller cross-sectional area than the cross-sectional area of the passage at the one end; and a capillary held within the passage, having an internal passage having a smaller cross-sectional area than the cross-sectional area of the narrowed portion, and airtightly sealed between its outer circumference and an inner circumference of the passage;
a second flow-path-narrowing section having a second housing identical in shape to the first housing, without having the capillary and the hermetic support member; and
a three-way valve having an outlet end, a first inlet end connected to the other end of the passage in the first flow-path-narrowing section, and a second inlet end connected to the other end of the passage in the second flow-path-narrowing section, the three-way valve configured to be alternatively switchable between a first state in which the outlet end is connected to the first inlet end and a second state in which the outlet end is connected to the second inlet end.

A flow rate switching mechanism according to another mode of the present invention may include:
a first flow-path-narrowing section including: a first housing with a passage internally bored through, the passage having a narrowed portion at a distance from one end of the passage, and the narrowed portion having a smaller cross-sectional area than the cross-sectional area of the passage at the one end; and a capillary held within the passage, having an internal passage having a smaller cross-sectional area than the cross-sectional area of the narrowed portion, and airtightly sealed between its outer circumference and an inner circumference of the passage;
a second flow-path-narrowing section having a second housing identical in shape to the first housing, without having the capillary and the hermetic support member;
a three-way valve having an inlet end, a first outlet end connected to the one end of the passage in the first flow-path-narrowing section, and a second outlet end connected to one end of the passage in the second flow-path-narrowing section, the three-way valve configured to be alternatively switchable between a first state in which the inlet end is connected to the first outlet end and a second state in which the inlet end is connected to the second outlet end; and
a branching tube having an outlet port, a first inlet port connected to the other end of the passage in the first flow-path-narrowing section, and a second inlet port connected to the other end of the second flow-path-narrowing section.

A mass spectrometer according to the present invention developed for solving the previously described problem includes:
a vacuum chamber;
a first pump having a suction port and a discharge port, the suction port connected to the vacuum chamber;
the second pump having a suction port and a discharge port, the discharge port being open to ambient air;
a connection tube connecting the discharge port of the first pump and the suction port of the second pump;
an air supply tube having one end connected to a halfway point on the connection tube, for supplying air into the connection tube;
a flow rate switching mechanism configured to switch the flow rate of the air introduced from the air supply tube into the connection tube; and
a controller;
   where:
the flow rate switching mechanism is a flow rate switching mechanism according to the one mode of the present invention;
the outlet end of the three-way valve in the flow rate switching mechanism is connected to an other end of the air supply tube; and
the controller is configured to control the three-way valve so that the three-way valve is in the first state when a mass spectrometric analysis is performed, and the three-way valve is in the second state during a standby period in which the first pump and the second pump are in operation and yet no mass spectrometric analysis is performed.

A mass spectrometer according to the present invention may include:
a vacuum chamber;
a first pump having a suction port and a discharge port, the suction port connected to the vacuum chamber;
the second pump having a suction port and a discharge port, the discharge port being open to ambient air;
a connection tube connecting the discharge port of the first pump and the suction port of the second pump;
an air supply tube having one end connected to a halfway point on the connection tube, for supplying air into the connection tube;
a flow rate switching mechanism configured to switch the flow rate of the air introduced from the air supply tube into the connection tube; and
a controller;
   where:
the flow rate switching mechanism is a flow rate switching mechanism according to the another mode of the present invention;
the outlet port of the branching tube in the flow rate switching mechanism is connected to an other end of the air supply tube; and
the controller is configured to control the three-way valve so that the three-way valve is in the first state when a mass spectrometric analysis is performed, and the three-way valve is in the second state during a standby period in which the first pump and the second pump are in operation and yet no mass spectrometric analysis is performed.

### Advantageous Effects of Invention

By the flow rate switching mechanism or mass spectrometer according to the present invention, the switching of the flow rate can be realized at low cost, and the control related to the switching of the flow rate will also be easier.

### BRIEF DESCRIPTION OF DRAWINGS

FIG. 1 is a model diagram showing a schematic configuration of a mass spectrometer according to one embodiment of the present invention.

FIG. 2 is a diagram showing one example of a specific configuration of the air supplier in the embodiment.

FIG. 3 is a sectional view showing the configuration of the second flow-path-narrowing section in the embodiment.

FIG. 4 is a sectional view showing the configuration of the first flow-path-narrowing section in the embodiment.

FIG. 5 is a flowchart showing an operation of the mass spectrometer according to the embodiment.

FIG. 6 is a model diagram showing a schematic configuration of a mass spectrometer according to another embodiment of the present invention.

FIG. 7 is a model diagram showing a schematic configuration of a conventional mass spectrometer.

### DETAILED DESCRIPTION

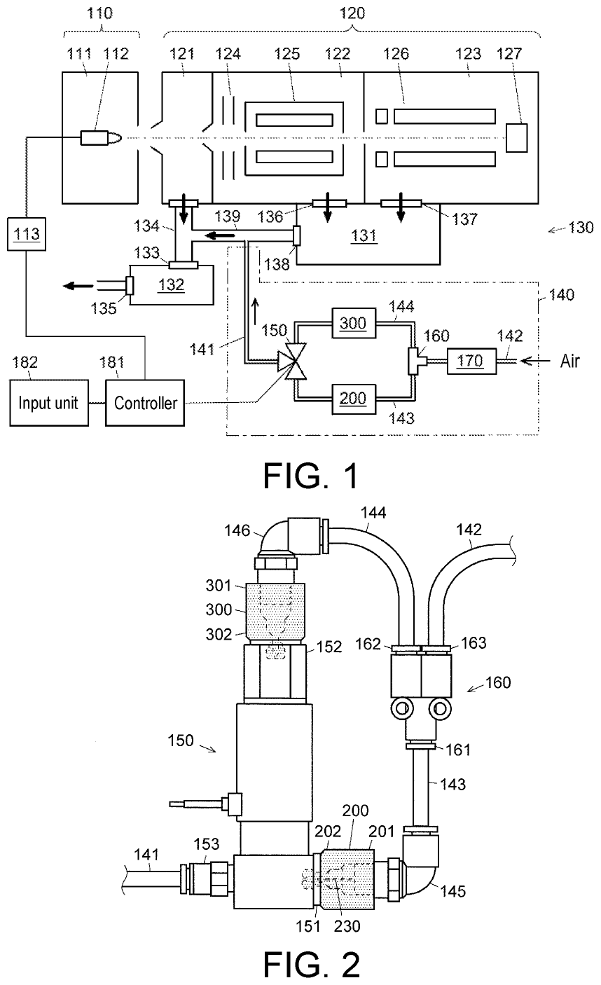

A mode for carrying out the present invention is hereinafter described with reference to the drawings. FIG. 1 is a model diagram showing a schematic configuration of a mass spectrometer according to the present embodiment. The present mass spectrometer includes an ionizing section 110 configured to generate ions from a sample by inductively coupled plasma, an analyzing section 120 configured to detect resultant ions after performing mass separation of the ions, an evacuating section 130 configured to evacuate the inner space of the analyzing section 120, and a controller 181 configured to control the operations of the aforementioned sections.

The ionizing section 110 includes an ionization chamber 111 at substantially atmospheric pressure and a plasma torch 112 located within the ionization chamber 111. The plasma torch 112 includes a sample tube through which a liquid sample atomized by nebulizer gas is to be passed, a plasma gas tube formed around the sample tube, a cooling gas tube formed around the plasma gas tube, and a radio-frequency induction coil wound around the tip of the cooling gas tube (these elements are omitted in the figure). An autosampler 113 configured to introduce a liquid sample into the plasma torch 112 is provided at the inlet end of the sample tube of the plasma torch 112. Plasma is generated at the tip of the plasma torch 112 when a radio-frequency current is flowed through the radio-frequency induction coil while plasma generation gas, such as argon gas, is being passed through the plasma gas tube. When a sample is introduced from the sample tube in this situation, the compounds in the sample are ionized in the high-temperature plasma, and the generated ions are directed to the analyzing section 120.

The analyzing section 120 has a first vacuum chamber 121, second vacuum chamber 122 and third vacuum chamber 123 arranged in this order from the ionizing section 111, having the configuration of a multi-stage differential pumping system in which the degrees of vacuum of the chambers are increased in a stepwise manner in the mentioned order. Although the present embodiment assumes that the analyzing section 120 consists of three vacuum chambers, the number of compartments forming the vacuum chambers may be appropriately changed. The first vacuum chamber 121 functions as an interface for forwarding ions supplied from the ionization chamber 111 to the subsequent stage, as well as discharging the solvent gas and other unnecessary types of gas. A substantially conical sampling cone is provided on the wall on the entrance side of the first vacuum chamber 121. The sampling cone has a micro-sized ion passage hole formed at its apex, through which the ions are introduced into the first vacuum chamber 121. The second vacuum chamber 122 contains an ion lens 124 for converging the flight path of the ions and a collision cell 125 for removing interfering ions, such as polyatomic ions, by causing the ions to collide with inert gas, such as helium gas. The third vacuum chamber 123 contains a quadrupole mass filter 126 configured to separate ions from each other based on their masses (or strictly speaking, m/z) and a detector 127 configured to detect the sample after the mass separation. The first and second vacuum chambers 121 and 122, as well as the second and third vacuum chambers 122 and 123, communicate with each other through a micro-sized ion passage hole. Although the present embodiment assumes that the mass separation of the ions is performed by the quadrupole mass filter 126, it is also possible to perform the mass separation by a mechanism different from quadrupole mass filters.

The evacuating section 130 includes a turbo-molecular pump 131 (which corresponds to the first pump in the present invention) and a rotary pump 132 (which corresponds to the second pump in the present invention). The turbo-molecular pump 131 has two suction ports 136 and 137 as well as one discharge port 138. The rotary pump 132 has one suction port 133 and one discharge port 135. The suction port 133 of the rotary pump 132 is connected to the first vacuum chamber 121 via a first tube 134, while the discharge port 135 of the same pump is open to the ambient air. As for the two suction ports 136 and 137 of the turbo-molecular pump 131, one suction port 136 is directly connected to the second vacuum chamber 122, while the other suction port 137 is directly connected to the third vacuum chamber 123. The discharge port 138 of the turbo-molecular pump 131 is connected to a halfway point on the first tube 134 via the second tube 139 (the section of the first tube 134 on the downstream side from the aforementioned halfway point and the second tube 139 correspond to the connection tube in the present invention). In the present embodiment, the rotary pump 132 acts as a pump for evacuating the first vacuum chamber 121 to a desired degree of vacuum and maintaining this degree of vacuum, as well as a roughing vacuum pump for evacuating the second and third vacuum chambers 122 and 123 to a pressure level from which the evacuation by the turbo-molecular pump 131 is possible, and also acts as an auxiliary pump for maintaining the back pressure of the turbo-molecular pump 131 by removing air expelled from the turbo-molecular pump 131. On the other hand, the turbo-molecular pump 131 acts as a pump for further evacuating the second and third vacuum chambers 122 and 123 already evacuated to the predetermined pressure level by the rotary pump 132, so as to achieve a desired degree of vacuum within those chambers and maintain this degree of vacuum.

As noted earlier, for a sufficient removal of hydrogen or similar light-weight gases by the turbo-molecular pump 131, it is necessary to introduce a gas having a large molecular weight into the section between the turbo-molecular pump 131 and the rotary pump 132. For this purpose, the evacuating section 130 is equipped with an air supplier 140 for sending a small amount of air into the second tube 139. Furthermore, as noted earlier, the flow rate of this air introduced into the second tube 139 needs to be relatively high during the standby period of the mass spectrometer while the same flow rate needs to be relatively low during the analysis execution period. To this end, the air supplier 140 is configured to allow the flow rate of the air into the second tube 139 to be switched between the standby and analysis execution periods. A detailed description of this air supplier 140 is hereinafter given.

An example of a specific configuration of the air supplier 140 in the present embodiment is shown in FIG. 2. The air supplier 140 includes a first flow-path-narrowing section 200, second flow-path-narrowing section 300, three-way valve 150, branching tube 160 and air filter 170 (although the air filter 170 is omitted in FIG. 2), with each of these components configured to allow a flow of gas to pass through. The first flow-path-narrowing section 200, second flow-path-narrowing section 300 and three-way valve 150 correspond to the flow rate switching mechanism in the present invention. The three-way valve 150, which is a solenoid valve or motor-operated valve having two inlet ends (which are hereinafter called the “first inlet end 151” and the “second inlet end 152”) and one outlet end 153, is configured to be alternatively switchable between a first state in which the first inlet end 151 is connected to the outlet end 153 and a second state in which the second inlet end 152 is connected to the outlet end 153. The branching tube 160 has three open ends (which are hereinafter called the “first open end 161”, “second open end 162” and “third open end 163”). The first flow-path-narrowing section 200 has one inlet end 201 and one outlet end 202. Similarly, the second flow-path-narrowing section 300 also has one inlet end 301 and one outlet end 302. The outlet end 153 of the three-way valve 150 is connected to a halfway point on the second tube 139 via a third tube 141 (which corresponds to the air supply tube in the present invention). The third open end 163 of the branching tube 160 is open to the ambient air via a fourth tube 142. The air filter 170 is provided in the middle of the fourth tube 142. The inlet end 201 of the first flow-path-narrowing section 200 is connected to the first open end 161 of the branching tube 160 via a fifth tube 143, while the outlet end 202 of the first flow-path-narrowing section 200 is directly connected to the first inlet end 151 of the three-way valve 150. The inlet end 301 of the second flow-path-narrowing section 300 is connected to the second open end 162 of the branching tube 160 via a sixth tube 144, while the outlet end 302 of the second flow-path-narrowing section 300 is directly connected to the second inlet end 152 of the three-way valve 150. The first flow-path-narrowing section 200 and the fifth tube 143 are coupled to each other via a first joint 145, while the second flow-path-narrowing section 300 and the sixth tube 144 are coupled to each other via a second joint 146.

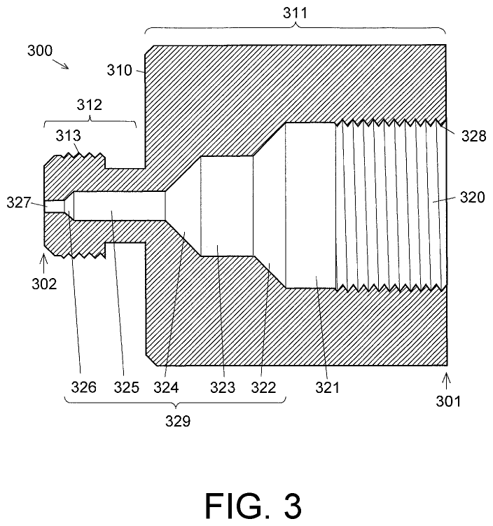

Each of the first and second flow-path-narrowing sections 200 and 300 is a section in which the flow rate of the air flowing into the second tube 139 is limited by reducing the cross-sectional area of the flow path which the air passes through. Hereinafter, the second flow-path-narrowing section 300, which has a simpler configuration, is initially described with reference to FIG. 3. The end located on the right side in this figure is the inlet end 301 of the second flow-path-narrowing section 300, while the end on the left side of the same figure is the outlet end 302 of the second flow-path-narrowing section 300. The second flow-path-narrowing section 300 has a housing 310 having a sectional shape as shown in FIG. 3. Although the housing 310 is typically made of metal, the material is not limited to this example; it may be made of hard plastic, ceramic or other types of materials. The housing 310 includes a substantially columnar body 311, as well as a projection 312 having a columnar shape with a smaller outer diameter than the body 311 and projecting from the end face of the body 311 opposite to the inlet end 301. The projection 312 is a portion to be screwed into the second inlet end 152 of the three-way valve 150 and has a thread 313 formed on its outer circumferential surface.

Inside the housing 310, a passage 320 for a flow of air to pass through is bored through the same housing 310. This passage 320 has an opening on the end face at the inlet end 301 of the body 311 as well as another opening on the end face at the outlet end 302 of the projection 312. The passage 320 has a large-diameter section 321 located in the terminal portion at the inlet end 301 of the housing 310 and a small-diameter section 327 (which corresponds to the narrowed portion in the present invention) located in the terminal portion at the outlet end 302, as well as a reducing section 329 located between the large-diameter section 321 and the small-diameter section 327. The reducing section 329 has a first taper section 322, first intermediate section 323, second taper section 324, second intermediate section 325 and third taper section 326. The first taper section 322, first intermediate section 323, second taper section 324, second intermediate section 325 and third taper section 326 are provided in this order from the large-diameter section 321 toward the small-diameter section 327. The first intermediate section 323 has an inner diameter smaller than that of the large-diameter section 321, while the second intermediate section 325 has an inner diameter smaller than that of the first intermediate section 323 and larger than that of the small-diameter section 327. The first taper section 322 has an inner circumferential surface having a tapered shape whose diameter gradually decreases from the large-diameter portion 321 toward the first intermediate section 323, while the second taper section 324 has an inner circumferential surface having a tapered shape whose diameter gradually decreases from the first intermediate section 323 toward the second intermediate section 325. The third taper section 326 has an inner circumferential surface having a tapered shape whose diameter gradually decreases from the second intermediate section 325 toward the small-diameter section 327. It should be noted, however, that the reducing section 329 in the present invention is not limited to the previously described configuration; the minimum requirement of its configuration is that its cross-sectional area decreases from the large-diameter section 321 toward the small-diameter section 327 in a stepwise or continuous form. The area at the inlet end 301 of the large-diameter section 321 is the portion into which the end of the second joint 146 is to be screwed. Accordingly, a thread 328 is formed on the inner circumferential surface of the same area. In the present embodiment, both of the large-diameter and small-diameter sections 321 and 327 have a circular cross-sectional shape, where their inner diameters are within, but not limited to, a range from 5 mm to 10 mm for the large-diameter section 321 and a range from 0.3 mm to 1 mm for the small-diameter section 327. It should be noted that the projection 312 must have a certain thickness in its wall in order to ensure a sufficient mechanical strength for its connection with the second inlet end 152 of the three-way valve 150.

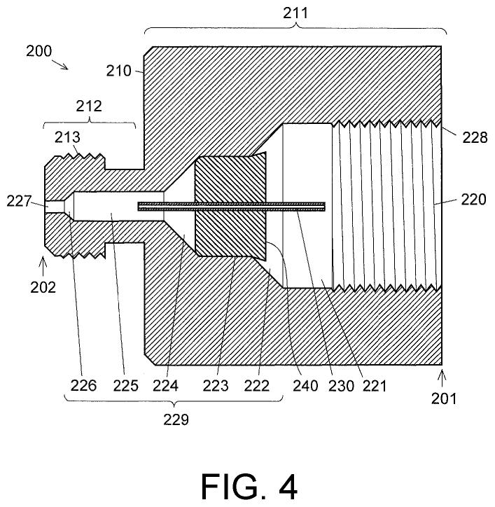

Subsequently, the configuration of the first flow-path-narrowing section 200 is described with reference to FIG. 4. It should be noted that some components in FIG. 4 which have corresponding components in FIG. 3 are denoted by numerals with the last two digits common to the two figures. As shown in FIG. 4, the first flow-path-narrowing section 200 has a housing 210, a capillary 230 arranged within the passage 220 in the housing 210 coaxially with the same passage 220, and a hermetic support member 240 configured to hold the capillary 230 and fix it in the passage 220. The shape, dimensions and material of the housing 210 are the same as those of the housing 310 of the second flow-path-narrowing section 300, and therefore, their descriptions will be omitted. The capillary 230 is a thin tube whose inner diameter is smaller than that of the small-diameter section 227 of the housing 210. The inner diameter of the capillary 230 should preferably be within a range from 0.05 mm to 0.5 mm, for example. There is no specific limitation on the outer diameter of the capillary 230; it may be larger or smaller than the inner diameter of the small-diameter section 227. The length of the capillary only needs to be shorter than the entire length of the passage 220. For example, the length should preferably be within a range from one third to two thirds of the passage. Although the tip of the capillary 230 (the end portion located on the side facing the outlet end 202) in FIG. 4 is located in the second intermediate section 225, its position is not limited to this case; for example, the tip of the capillary 230 may be located in the third taper section 226 or the small-diameter section 227. The capillary 230 is typically made of quartz but is not limited to this material; for example, it may be made of glass, hard resin, ceramic or metallic material. The hermetic support member 240 is a columnar member made of a rubber-elastic material, e.g., natural rubber, or synthetic rubber, such as silicone or urethane rubber, in which a capillary insertion hole (not shown) for inserting the capillary 230 is axially formed at its center. The outer diameter of the hermetic support member 240 is slightly larger than the inner diameter of the first intermediate section 223 of the housing 210. Accordingly, the hermetic support member 240, with the capillary 230 inserted through the capillary insertion hole, can be put through the opening at the inlet end 201 into the passage 220 and pressed into the first intermediate section 223 to thereby hold the capillary 230 within the passage 220. Furthermore, the hermetic support member 240 in this state provides an airtight seal between the outer circumference of the capillary 230 and the inner circumference of the passage 220. The projection 212 of the first flow-path-narrowing section 200 is to be screwed into the first inlet end 151 of the three-way valve 150, while the inlet end 201 of the large-diameter section 221 of the first flow-path-narrowing section 200 has an area into which an end of the first joint 145 is to be screwed.

The cross-sectional area of the small-diameter sections 227 and 327 of the housing 210 and 310 is sufficiently smaller than those of the flow path of the air in the other sections included in the air supplier 140 (i.e., the third tube 141, fourth tube 142, fifth tube 143, sixth tube 144, three-way valve 150, air filter 170, branching tube 160, first joint 145 and second joint 146). Furthermore, the small-diameter sections 227 and 327 have a circular cross-sectional shape, whose diameter is larger than the inner diameter of the capillary 230. Accordingly, the flow rate of the air flowing from the air supplier 140 into the second tube 139 depends on either the inner diameter of the capillary 230 in the first flow-path-narrowing section 200 or that of the small-diameter section 327 in the second flow-path-narrowing section 300, with the flow rate being larger when the three-way valve 150 is in the second state than when the same valve is in the first state.

The controller 181 is actually a personal computer or similar type of computer, for example, and a predetermined program is executed by the CPU provided in the computer to conduct an analysis of a sample by the mass spectrometer according to the present embodiment. An input unit 182, including a keyboard, mouse or other devices for allowing an operator to input instructions, is connected to the computer. For simplicity, FIG. 1 only shows control lines connecting the controller 181 with the three-way valve 150 or autosampler 113. Actually, the operations of the turbo-molecular pump 131 and the rotary pump 132, as well as the operations of the ionizing section 110 and the analyzing section 120 are also controlled by the controller 181.

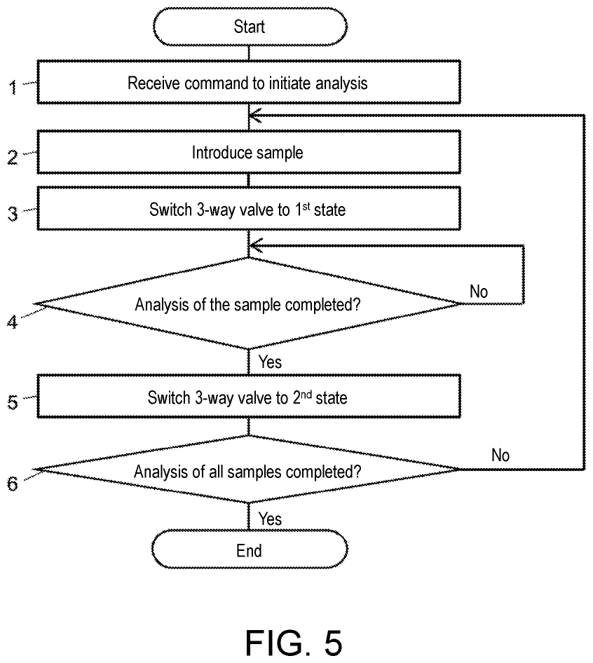

Subsequently, a characteristic operation in the mass spectrometer according to the present embodiment is described with reference to the flowchart in FIG. 5.

In a standby state before the initiation of an analysis, the first vacuum chamber 121, second vacuum chamber 122 and third vacuum chamber 123 are evacuated to their respective desired degrees of vacuum by the rotary pump 132 and the turbo-molecular pump 131. Furthermore, in this situation, the three-way valve 150 in the air supplier 140 is in the second state described earlier; the air that has flown into the fourth tube 142 of the air supplier 140 and has passed through the air filter 170 passes through the second flow-path-narrowing section 300, to ultimately flow into the second tube 139 via the three-way valve 150 and the third tube 141.

In the previously described situation, a command to initiate an analysis is issued by an operator or a previously set automatic analysis program (Step 1), whereupon, under the control of the controller 181, a liquid sample is introduced into the sample tube of the plasma torch 112 by the autosampler 113 (Step 2), and furthermore, under the control of the controller 181, the three-way valve 150 in the air supplier 140 is switched to the first state described earlier (Step 3). The air which has flown into the fourth tube 142 in the air supplier 140 and has passed through the air filter 170 now passes through the first flow-path-narrowing section 200 before flowing into the second tube 139 via the three-way valve 150 and the third tube 141. Steps 2 and 3 may be performed in the reverse order, or they may be performed simultaneously.

The sample introduced into the sample tube in Step 2 is ionized at the plasma torch 112, and the resultant ions are introduced into the analyzing section 120 and thereby analyzed. At a later time, when it is determined by the controller 181 that the analysis of the sample has been completed (i.e., when “Yes” in Step 4), the three-way valve 150 under the control of the controller 181 is once again switched to the second state (Step 5). Whether or not an analysis of a sample has been completed can be determined, for example, based on the magnitude of the detection signal from the detector 127, or based on whether or not a previously specified period of time has passed since the introduction of the sample by the autosampler 113.

Subsequently, the controller 181 determines whether or not the introduction into the ionizing section 110 and the analysis in the analyzing section 120 have been completed for all of the one or more previously set samples (Step 6). If there is a sample still remaining to be analyzed, the operation returns to Step 2 to perform Steps 3-6 once again. The entire process sequence will be completed when it is determined that the analysis of all samples has been completed (i.e., when “Yes” in Step 6).

Thus, in the mass spectrometer according to the present embodiment, the flow rate of the air supplied from the air supplier 140 to the second tube 139 can be set to be relatively low during the analysis execution period and relatively high during the standby period by switching the three-way valve 150 to the first state for the analyzing period and the second state for the standby period. The use of the housings 210 and 310 of identical configuration in the first and second flow-path-narrowing sections 200 and 300, with their difference in flow-limiting effect realized by the presence or absence of the capillary 230, allows the production cost to be reduced through the common use of the parts.

In the mass spectrometer according to the present embodiment, as described earlier, the first flow-path-narrowing section 200 is configured so that the capillary 230 is held within the housing 210, and the ends of the housing 210 are connected to the members which form the upstream and downstream flow paths (the three-way valve 150 and the joint 145). By this configuration, the function of reducing the flow rate of the air supplied from the air supplier 140 into the second flow path 139 to a level required during the analysis execution period, and the function of connecting the first flow-path-narrowing section 200 to the upstream and downstream passages, are separately realized by different parts (i.e., the capillary 230 and the housing 210). Therefore, the mass spectrometer according to the present embodiment neither requires direct connection of the capillary 230 to the three-way valve 150, joint 145 or other members, nor requires the creation of a deep hole having an extremely small inner diameter, as required in the capillary 230, in the housing 210 configured to be directly connected to the aforementioned members. This facilitates the production of the first flow-path-narrowing section 200 and allows for a further decrease in production cost.

Furthermore, in the mass spectrometer according to the present embodiment, since the operation of alternatively using either the first or second flow-path-narrowing section 200 or 300 for the limitation of the flow rate can be performed by switching the single three-way valve 150, the control related to the switching of the flow rate can be simplified. The provision of the single air filter 170 for the two flow-path-narrowing sections 200 and 300 reduces the number of parts as well as facilitates the management of the frequency of the replacement of the consumable air filter 170 and other related tasks.

One mode for carrying out the present invention has been described so far, presenting specific examples. It should be noted that the present invention is not limited to the previously described embodiment, which is allowed to be changed or modified within the spirit of the present invention. For example, the present invention is not limited to a mass spectrometer configured to ionize a sample by inductively coupled plasma; it may be any type of mass spectrometer. The flow rate switching mechanism according to the present invention can be applied not only in mass spectrometers but also in any type of device having a vacuum chamber, a first pump for evacuating the vacuum chamber, and a second pump for removing gas expelled from the first pump. The first and second pumps in the present invention may be any types of pumps and are not limited to a turbo-molecular pump and a rotary pump as in the previous description.

The hermetic support member in the present invention is not limited to the hermetic support member 240 in the previously described embodiment which has both the function of supporting the capillary 230 within the passage 220 and the function of providing a seal between the outer circumference of the capillary 230 and the inner circumference of the passage 220. For example, it may be the combination of a support member to be arranged within the passage 220 and a seal member, such as an O ring, for sealing an area between the outer circumferential surface of the support member and the inner circumferential surface of the passage 220, where the support member is a block, ferrule or similar member made of metal or resin (or the like) having a hole through which the capillary 230 is to be inserted. In this case, the support member may be fixed within the passage by the seal member, or it may be fixed within the passage 220 by means of screws (or the like) radially inserted from the outer circumference of the housing 210.

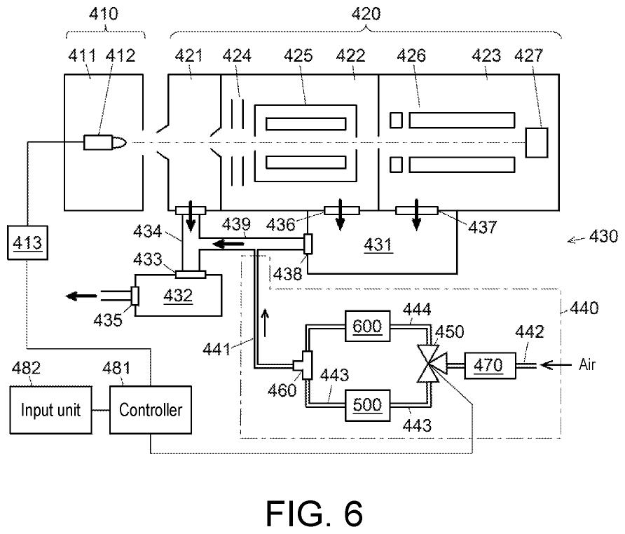

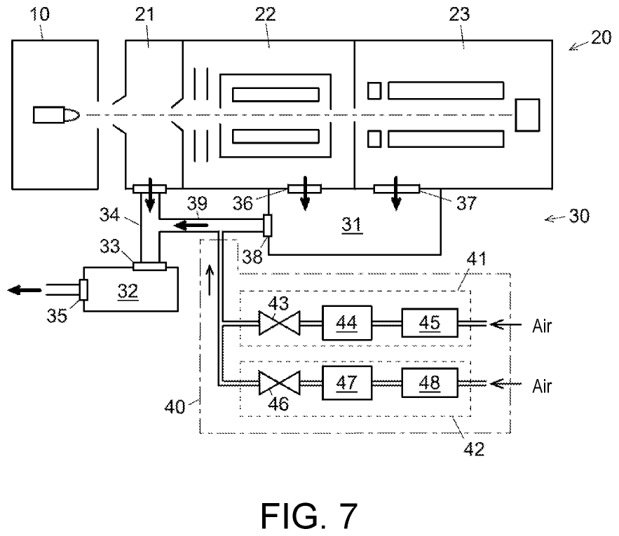

In the previously described embodiment, the branching tube 160 is arranged in the upstream area of the air flow in the air supplier 140, while the three-way valve 150 is arranged in the downstream area. It is also possible to arrange the three-way valve 150 in the upstream area and the branching tube 160 in the downstream area. A configuration example of this type of mass spectrometer is shown in FIG. 6. It should be noted that some components in FIG. 6 which have identical or corresponding components in FIG. 1 are denoted by numerals with the last two digits common to the two figures, and descriptions of those components will be appropriately omitted. Furthermore, the first and second flow-path-narrowing sections 500 and 600 in the present configuration example are identical in configuration to the first and second flow-path-narrowing sections 200 and 300 in the previously described embodiment, respectively, and therefore, detailed descriptions of those sections will be omitted. In the configuration shown in FIG. 6, the three-way valve 450 is a solenoid valve or motor-operated valve having one inlet end and two outlet ends (hereinafter called the “first outlet end” and the “second outlet end”). The fourth tube 442 is connected to the inlet end. The inlet end of the first flow-path-narrowing section 500 is connected to the first outlet end via the fifth tube 443. The inlet end of the second flow-path-narrowing section 600 is connected to the second outlet end via the sixth tube 444. The branching tube 460 has three open ends, of which one open end (which corresponds to the first inlet port in the present invention) is connected to the outlet end of the first flow-path-narrowing section 500, while another open end (which corresponds to the second inlet port in the present invention) is connected to the outlet end of the second flow-path-narrowing section 600. The remaining open end (which corresponds to the outlet port in the present invention) is connected to the third tube 441 (which corresponds to the air supply tube in the present invention). The three-way valve 450 is configured to be alternatively switchable between a first state in which the inlet end is connected to the first outlet end and a second state in which the inlet end is connected to the second outlet end. The flow rate of the air supplied from the air supplier 440 to the second tube 439 can be set to be relatively low during the analysis execution period and relatively high during the standby period by switching the three-way valve 450 to the first state for the analysis execution period and the second state for the standby period.

### MODES

It is evident for a person skilled in the art that the previously described illustrative embodiments are specific examples of the following modes of the present invention.

(Clause 1) A flow rate switching mechanism according to one mode of the present invention includes:
a first flow-path-narrowing section including: a first housing with a passage internally bored through, the passage having a narrowed portion at a distance from one end of the passage, and the narrowed portion having a smaller cross-sectional area than a cross-sectional area of the passage at the one end; and a capillary held within the passage, having an internal passage having a smaller cross-sectional area than a cross-sectional area of the narrowed portion, and airtightly sealed between its outer circumference and an inner circumference of the passage;
a second flow-path-narrowing section having a second housing identical in shape to the first housing, without having the capillary and the hermetic support member; and
a three-way valve having an outlet end, a first inlet end connected to an other end of the passage in the first flow-path-narrowing section, and a second inlet end connected to an other end of the passage in the second flow-path-narrowing section, the three-way valve configured to be alternatively switchable between a first state in which the outlet end is connected to the first inlet end and a second state in which the outlet end is connected to the second inlet end.

(Clause 2) A flow rate switching mechanism according to another mode of the present invention includes:
a first flow-path-narrowing section including: a first housing with a passage internally bored through, the passage having a narrowed portion at a distance from one end of the passage, and the narrowed portion having a smaller cross-sectional area than a cross-sectional area of the passage at the one end; and a capillary held within the passage, having an internal passage having a smaller cross-sectional area than a cross-sectional area of the narrowed portion, and airtightly sealed between its outer circumference and an inner circumference of the passage;
a second flow-path-narrowing section having a second housing identical in shape to the first housing, without having the capillary and the hermetic support member;
a three-way valve having an inlet end, a first outlet end connected to the one end of the passage in the first flow-path-narrowing section, and a second outlet end connected to one end of the passage in the second flow-path-narrowing section, the three-way valve configured to be alternatively switchable between a first state in which the inlet end is connected to the first outlet end and a second state in which the inlet end is connected to the second outlet end; and
a branching tube having an outlet port, a first inlet port connected to an other end of the passage in the first flow-path-narrowing section, and a second inlet port connected to an other end of the second flow-path-narrowing section.

In the flow rate switching mechanism according to Clause 1 or 2, since the operation of alternatively using either the first or second flow-path-narrowing section for the limitation of the flow rate can be performed by switching a single three-way valve, the control related to the switching of the flow rate can be simplified. Furthermore, the use of the housings of identical configuration in the first and second flow-path-narrowing sections, with their difference in flow-limiting effect realized by the presence or absence of the capillary, allows the production cost to be reduced through the common use of the parts.

(Clause 3) A flow rate switching mechanism according to Clause 3 is a flow rate switching mechanism according to Clause 1 or 2, further including:
a hermetic support member configured to support the capillary within the passage and to provide a seal between an outer circumferential surface of the capillary and an inner circumferential surface of the passage,
wherein the hermetic support member is made of a rubber-elastic material having a through hole into which the capillary is to be inserted, the hermetic support member configured to be pressed into the passage.

The flow rate switching mechanism according to Clause 3 allows the production cost to be further reduced through structural simplification of the hermetic support member.

(Clause 4) A mass spectrometer according to one mode of the present invention includes:
a vacuum chamber;
a first pump having a suction port and a discharge port, the suction port connected to the vacuum chamber;
the second pump having a suction port and a discharge port, the discharge port being open to ambient air;
a connection tube connecting the discharge port of the first pump and the suction port of the second pump;
an air supply tube having one end connected to a halfway point on the connection tube, for supplying air into the connection tube;
a flow rate switching mechanism configured to switch the flow rate of the air introduced from the air supply tube into the connection tube; and
a controller;
   wherein:
the flow rate switching mechanism is a flow rate switching mechanism according to Clause 1;
the outlet end of the three-way valve in the flow rate switching mechanism is connected to an other end of the air supply tube; and
the controller is configured to control the three-way valve so that the three-way valve is in the first state when a mass spectrometric analysis is performed, and the three-way valve is in the second state during a standby period in which the first pump and the second pump are in operation and yet no mass spectrometric analysis is performed.

(Clause 5) A mass spectrometer according to another mode of the present invention includes:
a vacuum chamber;
a first pump having a suction port and a discharge port, the suction port connected to the vacuum chamber;
the second pump having a suction port and a discharge port, the discharge port being open to ambient air;
a connection tube connecting the discharge port of the first pump and the suction port of the second pump;
an air supply tube having one end connected to a halfway point on the connection tube, for supplying air into the connection tube;
a flow rate switching mechanism configured to switch the flow rate of the air introduced from the air supply tube into the connection tube; and
a controller;
   wherein:
the flow rate switching mechanism is a flow rate switching mechanism according to Clause 2;
the outlet port of the branching tube in the flow rate switching mechanism is connected to an other end of the air supply tube; and
the controller is configured to control the three-way valve so that the three-way valve is in the first state when a mass spectrometric analysis is performed, and the three-way valve is in the second state during a standby period in which the first pump and the second pump are in operation and yet no mass spectrometric analysis is performed.

In the mass spectrometer according to Clause 4 or 5, the flow rate of the air supplied to the connection tube through the air supply tube can be set to be relatively low when a mass spectrometric analysis is performed, or relatively high during the standby period. The use of the housings of identical configuration in the first and second flow-path-narrowing sections, with their difference in flow-limiting effect realized by the presence or absence of the capillary, allows the production cost to be reduced through the common use of the parts. Furthermore, since the operation of alternatively using either the first or second flow-path-narrowing section for the limitation of the flow rate can be performed by switching a single three-way valve, the control related to the switching of the flow rate can be simplified.

(Clause 6) A mass spectrometer according to Clause 6 is a mass spectrometer according to Clause 4 or 5, further including:
a hermetic support member configured to support the capillary within the passage and to provide a seal between an outer circumferential surface of the capillary and an inner circumferential surface of the passage,
wherein the hermetic support member is made of a rubber-elastic material having a through hole into which the capillary is to be inserted, the hermetic support member configured to be pressed into the passage.

The mass spectrometer according to Clause 6 allows the production cost to be further reduced through structural simplification of the hermetic support member.

### REFERENCE SIGNS LIST

110 . . . Ionizing Section
120 . . . Analyzing Section
121 . . . First Vacuum Chamber
122 . . . Second Vacuum Chamber
123 . . . Third Vacuum Chamber
130 . . . Evacuating Section
131 . . . Turbo-Molecular Pump
132 . . . Rotary Pump
134 . . . First Tube
139 . . . Second Tube
140 . . . Air Supplier
141 . . . Third Tube
150 . . . Three-Way Valve
160 . . . Branching Tube
170 . . . Air Filter
200 . . . First Flow-path-narrowing Section
210 . . . Housing
220 . . . Passage
227 . . . Small-Diameter Section
230 . . . Capillary
240 . . . Hermetic Support Member
300 . . . Second Flow-path-narrowing Section
310 . . . Housing
320 . . . Passage
327 . . . Small-Diameter Section
181 . . . Controller
182 . . . Input Unit

1. A flow rate switching mechanism, comprising:
a first flow-path-narrowing section including: a first housing with a passage internally bored through, the passage having a narrowed portion at a distance from one end of the passage, and the narrowed portion having a smaller cross-sectional area than a cross-sectional area of the passage at the one end; and a capillary held within the passage, having an internal passage having a smaller cross-sectional area than a cross-sectional area of the narrowed portion, and airtightly sealed between its outer circumference and an inner circumference of the passage;
a second flow-path-narrowing section having a second housing identical in shape to the first housing, without having the capillary and the hermetic support member; and
a three-way valve having an outlet end, a first inlet end connected to an other end of the passage in the first flow-path-narrowing section, and a second inlet end connected to an other end of the passage in the second flow-path-narrowing section, the three-way valve configured to be alternatively switchable between a first state in which the outlet end is connected to the first inlet end and a second state in which the outlet end is connected to the second inlet end.

2. A flow rate switching mechanism, comprising:
a first flow-path-narrowing section including: a first housing with a passage internally bored through, the passage having a narrowed portion at a distance from one end of the passage, and the narrowed portion having a smaller cross-sectional area than a cross-sectional area of the passage at the one end; and a capillary held within the passage, having an internal passage having a smaller cross-sectional area than a cross-sectional area of the narrowed portion, and airtightly sealed between its outer circumference and an inner circumference of the passage;
a second flow-path-narrowing section having a second housing identical in shape to the first housing, without having the capillary and the hermetic support member;
a three-way valve having an inlet end, a first outlet end connected to the one end of the passage in the first flow-path-narrowing section, and a second outlet end connected to one end of the passage in the second flow-path-narrowing section, the three-way valve configured to be alternatively switchable between a first state in which the inlet end is connected to the first outlet end and a second state in which the inlet end is connected to the second outlet end; and
a branching tube having an outlet port, a first inlet port connected to an other end of the passage in the first flow-path-narrowing section, and a second inlet port connected to an other end of the second flow-path-narrowing section.

3. The flow rate switching mechanism according to claim 1, further comprising:
a hermetic support member configured to support the capillary within the passage and to provide a seal between an outer circumferential surface of the capillary and an inner circumferential surface of the passage,
wherein the hermetic support member is made of a rubber-elastic material having a through hole into which the capillary is to be inserted, the hermetic support member configured to be pressed into the passage.

4. A mass spectrometer, comprising:
a vacuum chamber;
a first pump having a suction port and a discharge port, the suction port connected to the vacuum chamber;
the second pump having a suction port and a discharge port, the discharge port being open to ambient air;
a connection tube connecting the discharge port of the first pump and the suction port of the second pump;
an air supply tube having one end connected to a halfway point on the connection tube, for supplying air into the connection tube;
a flow rate switching mechanism configured to switch the flow rate of the air introduced from the air supply tube into the connection tube; and
a controller;
wherein:
the flow rate switching mechanism is a flow rate switching mechanism according to claim 1;
the outlet end of the three-way valve in the flow rate switching mechanism is connected to an other end of the air supply tube; and
the controller is configured to control the three-way valve so that the three-way valve is in the first state when a mass spectrometric analysis is performed, and the three-way valve is in the second state during a standby period in which the first pump and the second pump are in operation and yet no mass spectrometric analysis is performed.

5. A mass spectrometer, comprising:
a vacuum chamber;
a first pump having a suction port and a discharge port, the suction port connected to the vacuum chamber;
the second pump having a suction port and a discharge port, the discharge port being open to ambient air;
a connection tube connecting the discharge port of the first pump and the suction port of the second pump;
an air supply tube having one end connected to a halfway point on the connection tube, for supplying air into the connection tube;
a flow rate switching mechanism configured to switch the flow rate of the air introduced from the air supply tube into the connection tube; and
a controller;
wherein:
the flow rate switching mechanism is a flow rate switching mechanism according to claim 2;
the outlet port of the branching tube in the flow rate switching mechanism is connected to an other end of the air supply tube; and
the controller is configured to control the three-way valve so that the three-way valve is in the first state when a mass spectrometric analysis is performed, and the three-way valve is in the second state during a standby period in which the first pump and the second pump are in operation and yet no mass spectrometric analysis is performed.

6. The mass spectrometer according to claim 4, further comprising:
a hermetic support member configured to support the capillary within the passage and to provide a seal between an outer circumferential surface of the capillary and an inner circumferential surface of the passage,
wherein the hermetic support member is made of a rubber-elastic material having a through hole into which the capillary is to be inserted, the hermetic support member configured to be pressed into the passage.
